(19) United States
(12) Patent Application Publication
(10) Pub. No.: US 2024/0331241 A1
(43) Pub. Date: Oct. 3, 2024

(54) IMAGE PROCESSING DEVICE, IMAGE PROCESSING METHOD, AND IMAGE PROCESSING PROGRAM

(71) Applicant: Socionext Inc., Kanagawa (JP)

(72) Inventors: Nobuyasu AKAIZAWA, Yokohama (JP); Takayuki KATO, Yokohama (JP); Katsuyuki OKONOGI, Yokohama (JP)

(21) Appl. No.: 18/738,962

(22) Filed: Jun. 10, 2024

Related U.S. Application Data
(63) Continuation of application No. PCT/JP2021/047333, filed on Dec. 21, 2021.

(51) Int. Cl. G06T 11/60

(52) U.S. Cl. CPC G06T 11/60

(57) ABSTRACT

Where a first bird's-eye-view image is generated by merging images obtained from multiple image capturing devices in a moving body together and an overlapping image is generated from accumulated images and overlaps the moving body, a second bird's-eye-view is generated by merging the first bird's-eye-view image and the overlapping image together. In the boundary portion formed between the first bird's-eye-view image and the overlapping image, a coefficient calculation part calculates adjustment coefficients for adjusting the property of the overlapping image based on property information of the first bird's-eye-view image and the accumulated images. An adjustment part adjusts the property of the overlapping image to be merged by the merging part based on the adjustment coefficients. By this means, it is possible to reduce the possibility that, when the first bird's-eye-view image and the overlapping image not included in the first bird's-eye-view image are merged together, the resulting image looks unnatural.

### CROSS-REFERENCE TO RELATED APPLICATION

The present application is a continuation application filed under 35 U.S.C. 111(a) claiming the benefit under 35 U.S.C. 120 and 365(c) of PCT International Application No. PCT/JP2021/047333, filed on Dec. 21, 2021, and designating the U.S. The entire contents of PCT International Application No. PCT/JP2021/047333 are incorporated herein by reference.

### BACKGROUND OF THE INVENTION

### 1. Field of the Invention

The present invention relates to an image processing device, an image processing method, and an image processing program.

### 2. Description of the Related Art

Systems for taking images of the surroundings of a moving vehicle by using image capturing devices, repeating generating bird's-eye-view images of the vehicle seen from above, and displaying the bird's-eye-view images generated thus on a display device, have long been in the public domain. Systems like these exclude areas where the brightness varies significantly due to the vehicle's shadows, reflections, and so forth, from the areas for creating past images, thereby preventing or substantially preventing striped portions where the brightness varies significantly from appearing near the subject vehicle in bird's-eye-view images. Also, given that the underneath of a vehicle is usually not included in the field of view that image capturing devices can cover, a method in which an image of the underneath of a vehicle is cut from past images that have been photographed earlier, and is overlaid on a currently photographed bird's-eye-view image of the vehicle, has also long been known.

### CITATION LIST

### Patent Document

[Patent Document 1] Unexamined Japanese Patent Application Publication No. 2014-13994
[Patent Document 2] Unexamined Japanese Patent Application Publication No. 2015-171106
[Patent Document 3] Unexamined Japanese Patent Application Publication No. 2014-36326
[Patent Document 4] Unexamined Japanese Patent Application Publication No. 2019-103344

### SUMMARY OF THE INVENTION

### Technical Problem

A bird's-eye-view image of a moving body that is generated on a real-time basis and an image of the underneath of the moving body to be overlaid on the bird's-eye-view image might vary in property such as brightness, because these images were photographed at different times. If their difference in property is significant, for example, the image of the underneath of the moving body may stand out when overlaid on the bird's-eye-view image, and make the bird's-eye-view image look unnatural.

The present invention has been made in view of the foregoing, and an object of the present invention is therefore to reduce the possibility that an image, in which a bird's-eye-view image of a moving body and its surroundings, and an overlapping image, which is an image of an area that overlaps the moving body but is not included in the bird's-eye-view image, are merged together, looks unnatural.

### Solution to Problem

According to one example of the present invention, an image processing device includes:
an image accumulating part configured to accumulate images obtained from a plurality of image capturing devices as accumulated images, the plurality of image capturing devices being provided in a moving body;
an overlapping image generating part configured to generate an overlapping image from accumulated images in the image accumulating part, the overlapping image showing an area that overlaps the moving body and is not included in a field of view of the plurality of image capturing devices;
a merging part configured to generate a first bird's-eye-view image that shows surroundings of the moving body by merging the images obtained from the plurality of image capturing devices together, and generate a second bird's-eye-view image by merging the first bird's-eye-view image and the overlapping image together;
a coefficient calculation part configured to calculate adjustment coefficients in a boundary portion formed between the first bird's-eye-view image and the overlapping image, based on property information of the first bird's-eye-view image and property information of the accumulated images used to generate the overlapping image; and
an adjustment part configured to adjust the property of the overlapping image to be merged with the first bird's-eye-view image by the merging part, based on the adjustment coefficients calculated by the coefficient calculation part.

### Advantageous Effects of Invention

According to the technology disclosed herein, it is possible to reduce the possibility that an image, in which a bird's-eye-view image of a moving body and its surroundings, and an overlapping image, which is an image of an area that overlaps the moving body but is not included in the bird's-eye-view image, are merged together, looks unnatural.

### BRIEF DESCRIPTION OF DRAWINGS

FIG. 1 is an image diagram that illustrates an example of an image processing system including an image processing device according to a first embodiment of the present invention;

FIG. 2 is a block diagram that illustrates an example functional structure of the image processing device of FIG. 1;

FIG. 3 is a block diagram that illustrates an example structure of the image processing device and information processing device of FIG. 2;

FIG. 4 is an explanatory view that illustrates examples of areas that can be photographed by the image capturing devices of FIG. 1 and an example of a projection surface on which the projection part of FIG. 2 projects images;

FIG. 5 is a plan view that illustrates an area underneath a vehicle, which is the underneath of the moving body of FIG. 4, and the projection surface;

FIG. 6 is an explanatory view that illustrates examples of bird's-eye-view images and accumulated images, each bird's-eye-view image incorporating an image of the underneath of the vehicle that changes as the moving body of FIG. 1 moves;

FIG. 7 is an explanatory view that illustrates an example coefficient calculation method that the coefficient calculation part of FIG. 2 uses;

FIG. 8 is an explanatory view that illustrates an example method of calculating adjustment coefficients that the image processing device of FIG. 2 uses to adjust the brightness of images of the underneath of a vehicle;

FIG. 9 is an explanatory view that illustrates an example method that the image processing device of FIG. 1 uses to generate images of the underneath of a vehicle;

FIG. 10 is a flowchart that illustrates an example operation of the image processing device of FIG. 2; and

FIG. 11 is an explanatory view that illustrates an example method of calculating adjustment coefficients that an image processing device according to a second embodiment uses to adjust the brightness of images of the underneath of a vehicle.

### DETAILED DESCRIPTION OF THE PREFERRED EMBODIMENTS

Embodiments of the present invention will be described below with reference to the accompanying drawings. In the following description, image data will also be simply referred to as “images.”

### First Embodiment

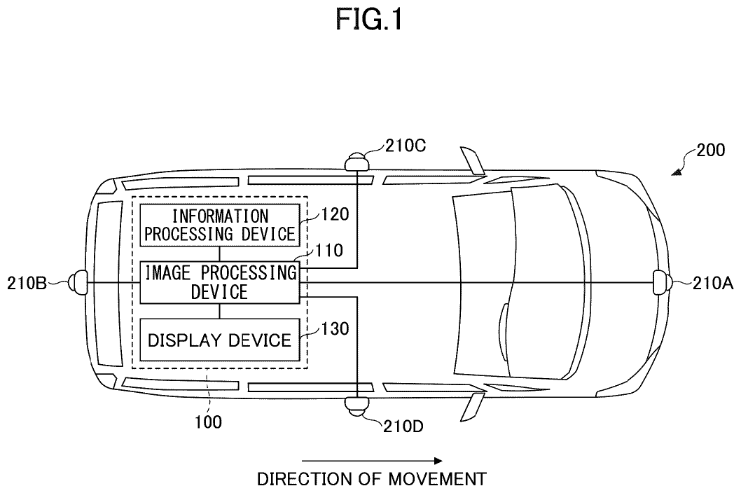

FIG. 1 is an image diagram that illustrates an example of an image processing system including an image processing device according to a first embodiment of the present invention. The image processing system 100 illustrated in FIG. 1 is installed, for example, in a moving body 200 such as an automobile. Image capturing devices 210A, 210B, 210C, and 210D, which may be cameras or the like, are installed on the front side, rear side, left side, and right side relative to the direction in which the moving body 200 moves. Below, the image capturing devices 210A, 210B, 210C, and 210D will also be referred to as “image capturing devices 210,” when described without distinction.

Note that the number and positions of the image capturing devices 210 to be installed in the moving body 200 are by no means limited to those illustrated in FIG. 1, as long as bird's-eye-view images of the moving body 200 can be generated. Also, the moving body 200, in which the image processing system 100 is mounted, is by no means limited to an automobile, and may be, for example, a transport robot or a drone used in a factory. In this case, the image processing system 100 may be installed outside the moving body 200 such that the image processing system 100 can communicate with the moving body 200.

The image processing system 100 includes an image processing device 110, an information processing device 120, and a display device 130. Note that, for ease of explanation, FIG. 1 overlays the image processing system 100 on an image diagram of the moving body 200 viewed from above. However, in reality, the image processing device 110 and the information processing device 120 are implemented on a control board or the like mounted in the moving body 200, and the display device 130 is installed in a position where a person inside the moving body 200 can see. Also, the image processing device 110 may be implemented on a control board or the like as a part of the information processing device 120, or may be implemented by an image processing program run by the information processing device 120.

The image processing device 110 is connected to each image capturing device 210 via a signal line or wirelessly, and obtains image data of images of the surroundings of the moving body 200 photographed by the image capturing devices 210. The image processing device 110 performs image processing (adjustment) on the image data obtained from each image capturing device 210, and outputs the results of image processing to at least one of the display device 130 or the information processing device 120. For example, the image processing device 110 can output a bird's-eye-view image of the moving body 200 and its surroundings, and an image of the underneath of the vehicle, which shows the underneath of the moving body 200 that cannot be photographed by the image capturing devices 210, to the display device 130.

The display device 130 may be, for example, the display of a navigation device installed in the moving body 200. If the moving body 200 moves backward, the display device 130 may display images of the rear of the moving body 200 on a real-time basis. Also, the display device 130 may display map images or the like output from the control part of the navigation device. Note that the display device 130 may be a display that is provided in the vehicle's dashboard or the like, or may be a head-up display that projects images onto a projection panel, windshield, and so on.

The information processing device 120 includes a computer, such as a processor that performs recognition and other processes based on image data that arrives via the image processing device 110. For example, the information processing device 120 mounted in the moving body 200 may detect other moving bodies, traffic lights, signs, lane markings, people, and so forth, by performing a recognition process on images indicated by image data, and determine the situation around the moving body 200 based on detection results.

Note that the information processing device 120 may function as a computer that controls each part of the moving body 200. Also, the information processing device 120 may have an autonomous driving control function to control the moving body 200 to move, stop, turn right, turn left, and so on. In this case, the information processing device 120 may identify an object outside the moving body 200 from an image generated by the image processing device 110, and track that identified object.

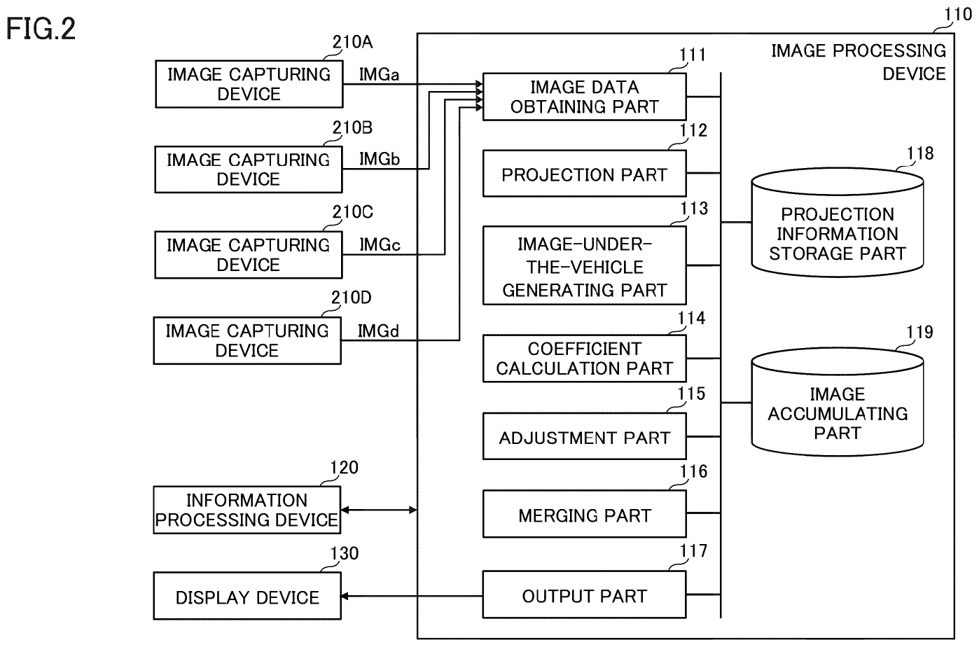

FIG. 2 is a block diagram illustrating an example functional structure of the image processing device 110 of FIG. 1. The image processing device 110 includes an image data obtaining part 111, a projection part 112, an image-under-the-vehicle generating part 113, a coefficient calculation part 114, an adjustment part 115, a merging part 116, an output part 117, a projection information storage part 118, and an image accumulating part 119.

The image processing device 110 may be implemented by hardware, or may be implemented by combining hardware and software together. For example, at least some of the functions of the projection part 112, image-under-the-vehicle generating part 113, coefficient calculation part 114, adjustment part 115, and merging part 116 may be implemented by an image processing program that is run by the image processing device 110. Also, some functions of the image data obtaining part 111 or some functions of the output part 117 may be implemented by an image processing program that is run by the image processing device 110.

The image data obtaining part 111 executes a process for obtaining image data IMG (IMGa, IMGb, IMGc, and IMGd) that shows images around the moving body 200, photographed by the image capturing devices 210 (210A, 210B, 210C, and 210D). The image data obtaining part 111 executes an accumulation process for storing image data IMG, obtained at least by image capturing devices 210 installed in the direction in which the moving body 200 moves, in the image accumulating part 119, as accumulated image data.

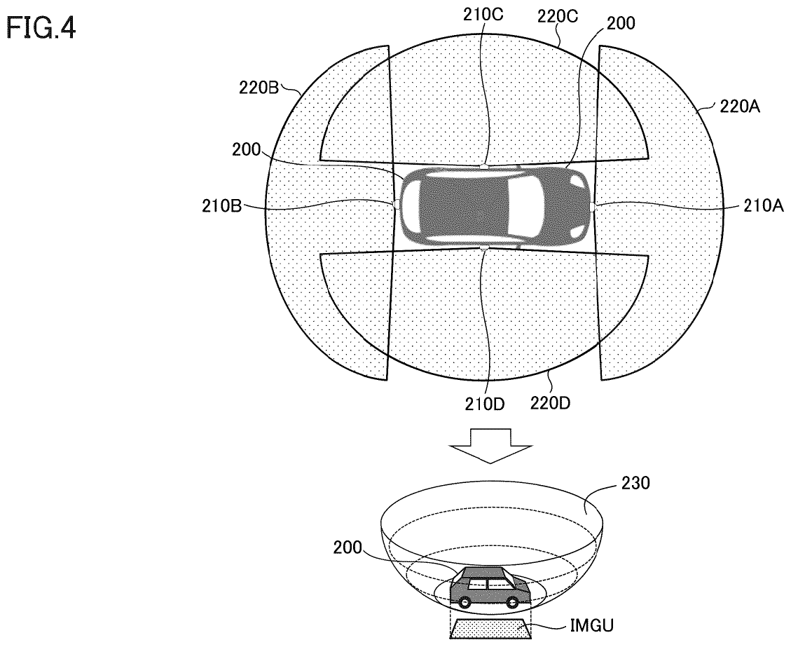

The projection part 112 executes a conversion process for converting the coordinates of each pixel included in image data IMGa to IMGd, obtained by the image data obtaining part 111, into coordinates for use when projecting the pixels onto a projection surface 230 (FIG. 4). The projection part 112 also performs a conversion process for converting the coordinates of each pixel included in an image of the underneath of the vehicle, which is generated by cutting out a part of the accumulated images stocked in the image accumulating part 119, into coordinates for use when projecting the pixels onto the projection surface 230. That is, the projection part 112 performs a conversion process for converting each of two-dimensional images IMGa to IMGd obtained by the image capturing devices 210A to 210D and the image of the underneath of the vehicle, into three-dimensional images suitable for the projection surface 230.

The image-under-the-vehicle generating part 113 executes a generation process, in which an image of the underneath of the vehicle is generated by cutting out a part of multiple accumulated images stocked in the image accumulating part 119. Also, the image-under-the-vehicle generating part 113 outputs the image of the underneath of the vehicle generated, and the coordinates of the image of the underneath of the vehicle on the projection surface 230, to the merging part 116. The image-under-the-vehicle generating part 113 obtains the coordinates of the image of the underneath of the vehicle on the projection surface 230, from the projection part 112. The image of the underneath of the vehicle is an example of an overlapping image, that is, an image of an area that overlaps the moving body 200 and is not included in the field of view of the image capturing devices 210A to 210D. The image-under-the-vehicle generating part 113 is an example of an overlapping image generating part that generates images of the underneath of the vehicle from accumulated images stocked in the image accumulating part 119.

Before the bird's-eye-view image and the image of the underneath of the vehicle are merged in the merging part 116, the coefficient calculation part 114 performs a coefficient calculation process in the boundary portion formed between these images, and calculates adjustment coefficients for making pixel information of the image of the underneath of the vehicle congruent with pixel information of the bird's-eye-view image. For example, assuming that there are a predetermined number of sampling points around the image of the underneath of the vehicle, the coefficient calculation part 114 calculates the ratio between the pixel information of the bird's-eye-view image and the pixel information of the accumulated images, from which the image of the underneath of the vehicle is cut out, at each of these sampling points.

Below, the adjustment coefficients will also be simply referred to as “coefficients.” Furthermore, although an example in which “pixel information” refers to brightness will be described below, pixel information may be color information as well, or may be both brightness and color information. That is, brightness may be indicated by both brightness values and color information. Pixel information is an example of property information of images.

The adjustment part 115 performs a adjustment process of adjusting the brightness of the image of the underneath of the vehicle based on the adjustment coefficients calculated by the coefficient calculation part 114. As a result of this, the difference in brightness between the bird's-eye-view image and the image of the underneath of the vehicle, obtained at different times, can be reduced, so that, even when the image of the underneath of the vehicle is incorporated in the bird's-eye-view image, it is still possible to generate a bird's-eye-view image that looks less awkward. That is, it is possible to reduce the possibility that, when a bird's-eye-view image and an image of the underneath of the vehicle are merged together, the resulting bird's-eye-view image looks unnatural.

Where three-dimensional image data is generated by the projection part 112 based on each of image data IMGa to IMGd, the merging part 116 performs a merging process of merging these three-dimensional image data together and generating a bird's-eye-view image. Also, the merging part 116 performs a merging process of merging the image of the underneath of the vehicle, cut out by the image-under-the-vehicle generating part 113, and the bird's-eye-view image together, and generating a bird's-eye-view image that incorporates the image of the underneath of the vehicle. Here, the bird's-eye-view image that is generated here by merging image data IMGa to IMGd together is an example of a first bird's-eye-view image, and the bird's-eye-view image that incorporates the image of the underneath of the vehicle is an example of a second bird's-eye-view image.

The output part 117 outputs image data of the bird's-eye-view images and the like to the display device 130. The display device 130 displays images that match the image data that arrives from the output part 117.

The projection information storage part 118 holds, for example, projection information that associates the two-dimensional coordinates of each pixel of image data IMGa to IMGd with three-dimensional coordinates of the projection surface 230. The projection information is referenced by the projection part 112. Also, the projection information storage part 118 holds projection information that associates the two-dimensional coordinates of each pixel of image data IMGa and IMGb, photographed in the direction in which the moving body 200 moves, with three-dimensional coordinates of the area underneath the vehicle on the projection surface 230.

The image accumulating part 119 accumulates the image data obtained by the image data obtaining part 111 as accumulated images. Note that the image accumulating part 119 may accumulate only the image data that the image data obtaining part 111 obtains from the image capturing device 210A or the image capturing device 210B, installed in the direction in which the moving body 200 moves, as accumulated images.

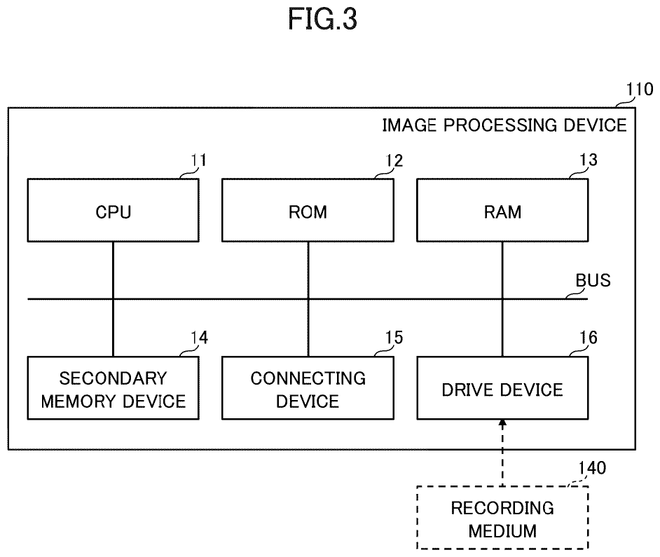

FIG. 3 is a block diagram that illustrates an example structure of the image processing device 110 and the information processing device 120 of FIG. 2. Since the image processing device 110 and the information processing device 120 are structured the same or substantially the same, the structure of the image processing device 110 alone will be described below. For example, the image processing device 110 includes a CPU (Central Processing Unit) 11, a ROM (Read-Only Memory) 12, a RAM (Random Access Memory) 13, a secondary memory device 14, a connecting device 15, and a drive device 16, which are all interconnected by a bus BUS.

The CPU 11 operates by running programs stored in the ROM 12, and controls the overall operation of the image processing device 110. The ROM 12 stores the programs that run on the CPU 11, various data used in the programs, and so forth. For example, the programs that run on the CPU 11 include an image processing program, a boot program such as the BIOS (Basic Input/Output System) or EFI (Extensible Firmware Interface) program, and so on.

The RAM 13 may be a volatile memory such as a DRAM (Dynamic Random Access Memory) or a SRAM (Static Random Access Memory), or may be a non-volatile memory such as a flash memory or the like in which information can be rewritten electrically. The RAM 13 may be used as a work area when transforming various programs installed in the secondary memory device 14 into programs that the CPU 11 can run.

The secondary memory device 14 stores a variety of information, including various programs transferred thereto from outside the image processing device 110 via the drive device 16, data for use in these programs, and so on. For example, the secondary memory device 14 may be an HDD (Hard Disk Drive) or an SSD (Solid State Drive). Note that the variety of information stored in the secondary memory device 14 may be transferred thereto from a network the connecting device 15 is connected to.

The connecting device 15 transmits and receives information, such as data, to and from external devices connected to the image processing device 110, such as the image capturing device 210, the information processing device 120, the display device 130, and so on, or between the image processing device 110 and the network.

For example, the connecting device 15 has signal terminals for receiving image data IMG from the image capturing devices 210 of FIG. 2, and transfers the received image data IMG to the image data obtaining part 111 of FIG. 2. The connecting device 15 has a signal terminal for outputting image data that is output from the output unit 117 of FIG. 2, to the display device 130. The connecting device 15 has a signal terminal for inputting and outputting information to and from the information processing device 120.

The drive device 16 has an interface where, for example, a computer-readable recording medium 140 is connected, receives information such as various programs or various data stored in the recording medium 140, and transfers the received information to the CPU 11 or the secondary memory device 14. For example, the recording medium 140 connected to the drive device 16 is a semiconductor memory such as a CD-ROM (Compact Disc Read-Only Memory), a flexible disk, a magneto-optical disk, or a flash memory that records information optically, electrically, or magnetically.

FIG. 4 is an explanatory view that illustrates examples of areas that can be photographed by the image capturing devices 210 of FIG. 1 and the projection surface 230 on which the projection part 112 of FIG. 2 projects images.

The image capturing device 210A can photograph objects included in an area 220A, which is on the front side of the moving body 200. The image capturing device 210B can photograph objects included in an area 220B, which is on the rear side of the moving body 200. The image capturing device 210C can photograph objects included in an area 220C, which is on the left side of the moving body 200. The image capturing device 210D can photograph objects included in an area 220D, which is on the right side of the moving body 200.

The areas 220A to 220D partly overlap each other. This allows the image capturing devices 210A to 210D to capture images of the surroundings of the moving body 200, except for its underneath. Each image capturing device 210 can in fact take pictures up to the horizon; but in FIG. 4, the areas 220A to 220D are shown in a fan-like shape.

The merging part 116 of FIG. 2 generates a bird's-eye-view image that is indicated by three-dimensional coordinates on the projection surface 230, by merging image data of the areas 220A to 220D, obtained from the image capturing devices 210A to 210D on a real-time basis. Also, the merging part 116 merges the bird's-eye-view image shown on the projection surface 230 and the image IMGU of the underneath of the vehicle, the brightness of which has been adjusted by the adjustment part 115, and thereupon a bird's-eye-view image that incorporates an image IMGU of the underneath of the vehicle is generated.

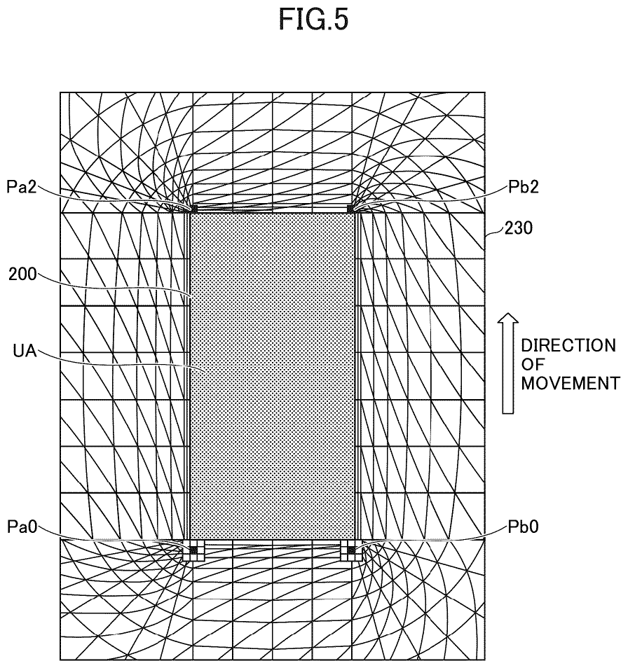

FIG. 5 is a plan view that illustrates an area UA underneath the vehicle, which is the underneath of the moving body 200 of FIG. 4, and the projection surface 230. The area UA underneath the vehicle is not included in the areas 220A to 220D in FIG. 4, and is an area which the image capturing devices 210A to 210D cannot photograph. However, strictly speaking, the area UA underneath the vehicle may include a little of the areas around the moving body 200.

The coefficient calculation part 114 of FIG. 2 sets sampling points Pa0, Pb0, Pa2, and Pb2 at the positions of the four vertices of the boundary portion formed between the areas 220A to 220D and the area UA underneath the vehicle. For example, on the side opposite the direction in which the moving body 200 moves, the coefficient calculation part 114 sets sampling points Pa0 and Pb0 at both left and right ends of areas neighboring the rear end of the area UA underneath the vehicle. Also, in the direction in which the moving body 200 moves, the coefficient calculation part 114 sets sampling points Pa2 and Pb2 at both left and right ends of areas neighboring the front end of the area UA underneath the vehicle. Each of sampling points Pa0, Pb0, Pa2, and Pb2 corresponds to one pixel of the bird's-eye-view image, but this is by no means a limitation.

Note that the positions of sampling points Pa0, Pb0, Pa2, and Pb2 may be set in advance and stored in one of the ROM 12, RAM 13, and secondary memory device 14 of FIG. 3. Also, sampling points Pa0 and Pb0 may be set at positions that neighbor the left and right rear ends of the area UA underneath the vehicle. Sampling points Pa2 and Pb2 may be set at positions that neighbor the left and right front ends of the area UA underneath the vehicle.

Upon obtaining a bird's eye-view image on a real-time basis, the coefficient calculation part 114 calculates the average brightness at sampling point Pa0 and at sampling point Pb0. Each average brightness is the average of the respective brightnesses of 9 pixels, consisting of the pixel of sampling point Pa0 or Pb0 and 8 pixels surrounding sampling point Pa0 or Pb0. Also, the coefficient calculation part 114 calculates the average brightness at sampling point Pa0 and at sampling point Pb0 in a past accumulated image stocked in the image accumulating part 119. Each average brightness is the average of the respective brightnesses of 9 pixels, consisting of the pixel of sampling point Pa0 or Pb0 and 8 pixels surrounding sampling point Pa0 or Pb0. Then, the coefficient calculation part 114 calculates the ratio between the respective average brightnesses of sampling point Pa0 and Pb0, as an adjustment coefficient. Note that the coefficient calculation part 114 sets the adjustment coefficient for sampling points Pa2 and Pb2 to “1.0,” regardless of the brightness. The adjustment coefficients for sampling points Pa0, Pb0, Pa2, and Pb2 are examples of reference adjustment coefficients.

The coefficient calculation part 114 uses multiple pixels, including the pixels of sampling points Pa0 and Pb0, in the calculation of average brightness. Consequently, even when, for example, the brightness of the pixel at sampling point Pa0 shows an irregular value due to noise or the like, it is still possible to calculate an average brightness within a normal range.

The coefficient calculation part 114 calculates reference adjustment coefficients at the positions of the vertices of the rectangular boundary portion formed between the areas 220A to 220D and the image IMGU of the underneath of the vehicle, and, using these reference adjustment coefficients, calculates the adjustment coefficient for each pixel of the image IMGU of the underneath of the vehicle. By thus calculating a minimal number of reference adjustment coefficients first, the coefficient calculation part 114 can calculate the adjustment coefficient for every pixel in the image IMGU of the underneath of the vehicle, and reduce the amount of calculation.

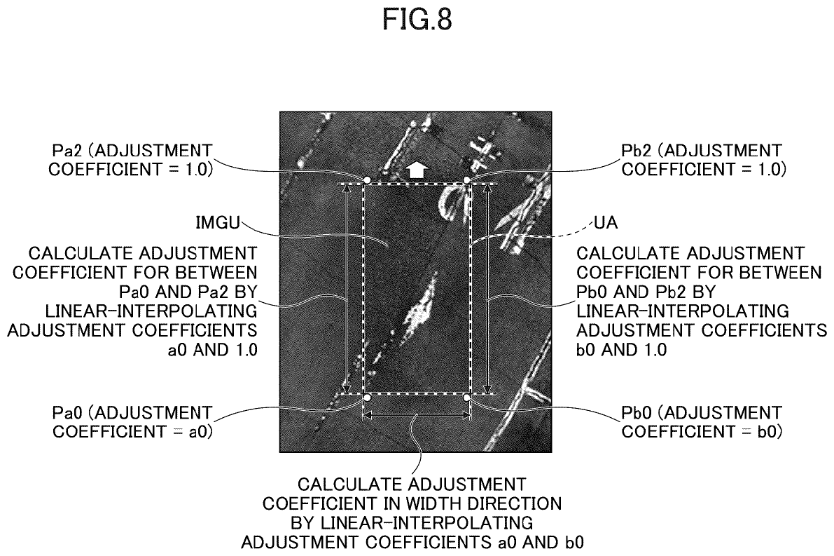

The adjustment part 115 adjusts the brightness of each pixel of the image IMGU of the underneath of the vehicle based on the adjustment coefficients for sampling point Pa0 and Pb0, calculated by the coefficient calculation part 114, and the adjustment coefficient (=1.0) for sampling points Pa2 and Pb2. The adjustment of each pixel's brightness in the image IMGU of the underneath of the vehicle will be described later with reference to FIG. 8.

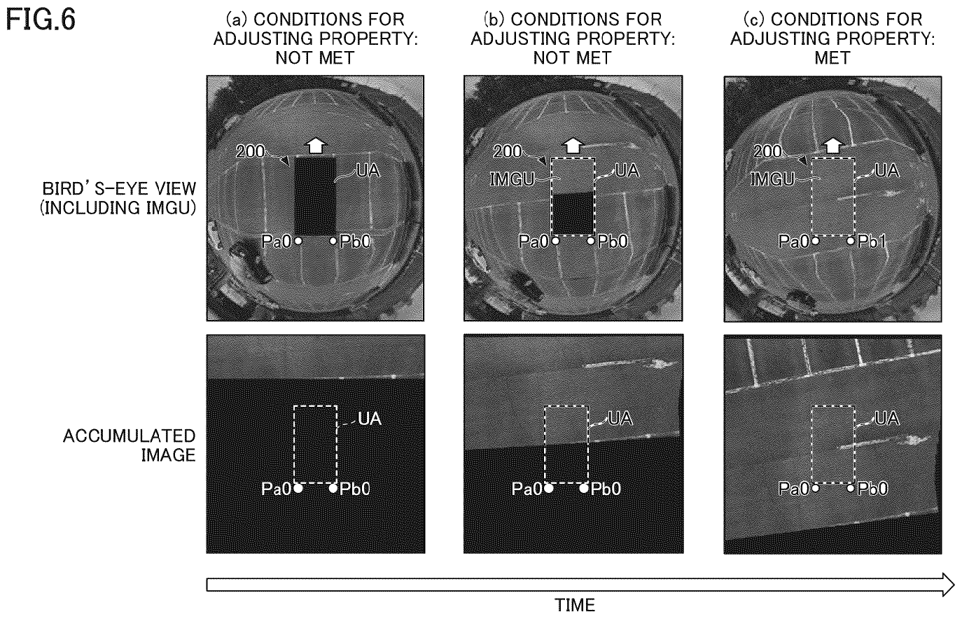

FIG. 6 is an explanatory view that illustrates examples of bird's-eye-view images and accumulated images, each bird's-eye-view image incorporating an image IMGU of the underneath of the vehicle that changes as the moving body 200 of FIG. 1 moves. For example, assume that a bird's-eye-view image incorporating an image IMGU of the underneath of the vehicle is displayed on the display device 130 on a real-time basis. The moving body 200 starts moving from the still state (a) of FIG. 6, in the direction indicated by the white arrow shown in the bird's-eye-view image, and transitions to (b) and (c) in FIG. 6 in order.

The accumulated images here refer to images that the image data obtaining part 111 has obtained from the image capturing device 210A or 210B located in the direction in which the moving body 200 moves, and stored in the image accumulating part 119. Although, for ease of explanation, FIG. 6 shows states in which accumulated images are displayed, the accumulated images are displayed on the display device 130 or the like only during development or maintenance of the image processing device 110.

In the still state (a) of FIG. 6, the entire accumulated image is an image of the front of the area UA underneath the vehicle or the moving body 200, so no image IMGU of the underneath of the vehicle is generated. In this case, the merging part 116 generates a bird's-eye-view image that incorporates no image IMGU of the underneath of the vehicle, and displays it on the display device 130 via the output part 117. The coefficient calculation part 114 does not calculate coefficients because the accumulated image shows no images of sampling points Pa0 and Pb0.

Referring to (b) in FIG. 6, the accumulated image obtained in (a) in FIG. 6 now includes a part of the area UA underneath the vehicle. The merging part 116 then generates a bird's-eye-view image, in which an image IMGU of the underneath of the vehicle showing a part of the area UA underneath the vehicle is incorporated, and displays the bird's-eye-view image on the display device 130 via the output part 117. The coefficient calculation part 114 calculates no adjustment coefficients because the accumulated image shows no images of sampling points Pa0 and Pb0. It then follows that the adjustment part 115 does not adjust the brightness of the image IMGU of the underneath of the vehicle incorporated in the bird's-eye-view image either.

Referring to (c) in FIG. 6, the accumulated image obtained through (a) and (b) in FIG. 6 now includes the entirety of the area UA underneath the vehicle. So, the merging part 116 merges the image IMGU of the underneath of the vehicle of the area UA underneath the vehicle and the bird's-eye-view image together, and displays the resulting image on the display device 130 via the output part 117. Now that the accumulated image includes images of sampling points Pa0 and Pb0, the coefficient calculation part 114 calculates the adjustment coefficients for use in adjusting the brightness of the image IMGU of the underneath of the vehicle.

The adjustment part 115 adjusts the brightness of the image IMGU of the underneath of the vehicle incorporated in the bird's-eye-view image by using the adjustment coefficients. That is, in (c) of FIG. 6, the brightness of the image IMGU of the underneath of the vehicle incorporated in the bird's-eye-view image is adjusted in accordance with the brightness of the bird's-eye-view image obtained on a real-time basis. This allows the image processing device 110 to generate an image IMGU of the underneath of the vehicle that does not look awkward compared to the bird's-eye-view image generated on a real-time basis. That is, when a bird's-eye-view image and an image IMGU of the underneath of the vehicle are merged together, it is possible to reduce the possibility that the resulting image looks unnatural.

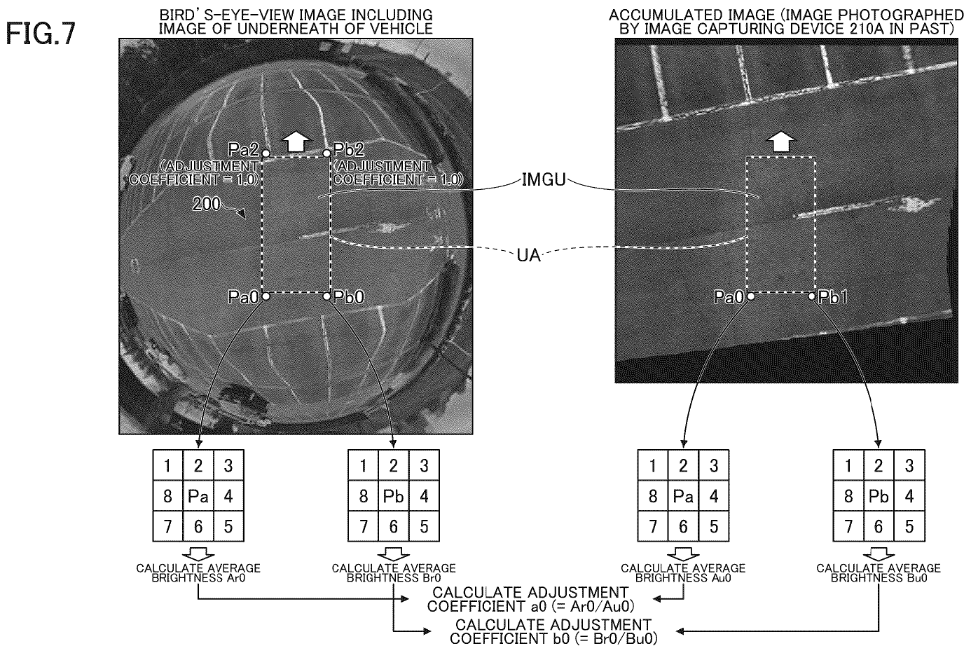

FIG. 7 is an explanatory view that illustrates an example coefficient calculation method that the coefficient calculation part of FIG. 2 uses. In FIG. 7, the bird's-eye-view image incorporating an image IMGU of the underneath of the vehicle and the accumulated image are the same as the bird's-eye-view image and accumulated image of (c) in FIG. 6. The white arrows illustrated in FIG. 7 indicate the direction in which the moving body 200 moves.

Upon obtaining a bird's eye-view image obtained on a real-time basis, the coefficient calculation part 114 calculates average brightnesses Ar0 and Br0. Each average brightness is the average of the respective brightnesses of the pixel of sampling point Pa0 or Pb0, located on the side opposite the direction in which the moving body 200 moves, and 8 pixels surrounding sampling point Pa0 or Pb0. Also, when the pixels of sampling points Pa0 and Pb0 are in the accumulated image, the coefficient calculation part 114 calculates average brightnesses Au0 and Bu0. Each average brightness is the average of the respective brightnesses of the pixel of sampling point Pa0 or Pb0 and 8 pixels surrounding sampling point Pa0 or Pb0.

The coefficient calculation part 114 makes Ar0/Au0, which is the ratio of the average brightnesses Ar0 and Au0, an adjustment coefficient a0. The coefficient calculation part 114 also makes Br0/Bu0, which is the ratio of the average brightnesses Br0 and Bu0, an adjustment coefficient b0. Note that the number of pixels to use to calculate the average brightnesses Ar0, Br0, Au0, and Bu0 is by no means limited to 9 pixels insofar as 2 or more pixels are used. Also, as described earlier, the coefficient calculation part 114 sets the adjustment coefficients a1 and b1 for sampling points Pa2 and Pb2, which are located in the direction in which the moving body 200 moves, to “1.0.”

For example, assuming that the adjustment coefficients a0 and b0 are greater than 1.0, the pixels in areas near sampling points Pa0 and Pb0 in the image IMGU of the underneath of the vehicle are likely to be less bright than in the bird's-eye-view image. Also, when the adjustment coefficients a0 and b0 are smaller than 1.0, the pixels in areas near sampling points Pa0 and Pb0 in the image IMGU of the underneath of the vehicle are likely to be brighter than in the bird's-eye-view image. Therefore, the adjustment part 115 multiplies the brightness of the pixels in areas near sampling points Pa0 and Pb0 in the image IMGU of the underneath of the vehicle by the adjustment coefficients, so that, in areas near sampling points Pa0 and Pb0, the brightness of the image IMGU of the underneath of the vehicle can be brought into accordance with the brightness of the bird's-eye-view image.

FIG. 8 is an explanatory view that illustrates an example method of calculating adjustment coefficients that the image processing device 110 of FIG. 2 uses to adjust the brightness of an image IMGU of the underneath of the vehicle. The method of adjustment coefficient calculation illustrated in FIG. 8 is started when any one of the accumulated images stocked in the image accumulating part 119 includes a predetermined number of pixels (for example, 9 pixels), including sampling points Pa0 and Pb0 of the area UA underneath the vehicle at the current position of the moving body 200.

As illustrated in FIG. 7, the coefficient calculation part 114 first calculates Ar0/Au0, which is the ratio between the average brightness Ar0 of a bird's-eye-view image and the average brightness Au0 of an accumulated image at sampling point Pa0, and sets the calculated ratio Ar0/Au0 as the adjustment coefficient a0 at sampling point Pa0. Also, the coefficient calculation part 114 calculates Br0/Bu0, which is the ratio between the average brightness Br0 of the bird's-eye-view image and the average brightness Bu0 of the accumulated image at sampling point Pb0, and sets the calculated ratio Br0/Bu0 as the adjustment coefficient b0 at sampling point Pb0.

Next, the coefficient calculation part 114 calculates the adjustment coefficient for each pixel in the area UA underneath the vehicle, between sampling points Pa0 and Pa2, by linear interpolation using the adjustment coefficient a0 and the adjustment coefficient=1.0 at sampling point Pa2. Similarly, the coefficient calculation part 114 calculates the adjustment coefficient for each pixel in the area UA underneath the vehicle, between sampling points Pb0 and Pb2, by linear interpolation using the adjustment coefficient b0 and the adjustment coefficient=1.0 at sampling point Pb2.

Furthermore, the coefficient calculation part 114 calculates the adjustment coefficient for each pixel arranged in the width direction of the moving body 200 in the area UA underneath the vehicle by linear interpolation using adjustment coefficients a and b, which pertain to the same positions in the direction in which the moving body 200 moves, in the area UA underneath the vehicle. Note that the coefficient calculation part 114 need not calculate adjustment coefficients by linear interpolation for every single pixel; instead, the coefficient calculation part 114 may calculate adjustment coefficients for every desired number of pixels.

As described above, the coefficient calculation part 114 can calculate adjustment coefficients for adjusting the brightness of all pixels in the area UA underneath the vehicle. The coefficient calculation part 114 calculates the adjustment coefficient for each pixel between sampling points Pa0 and Pa2 in the area UA underneath the vehicle, and calculates the adjustment coefficient for each pixel between sampling points Pb0 and Pb2 in the area UA underneath the vehicle by linear interpolation. When this takes place, because the pixels at the front end of the image IMGU of the underneath of the vehicle in the direction in which the moving body 200 moves show pixel values (for example, brightness values) that vary only slightly between the bird's-eye-view image and the image IMGU of the underneath of the vehicle, the adjustment coefficients for sampling points Pa2 and Pb2 can be set to “1.0,” regardless of the image.

Furthermore, the coefficient calculation part 114 calculates the adjustment coefficients for pixels arranged in the width direction of the image IMGU of the underneath of the vehicle by linearly interpolating the adjustment coefficients calculated for the pixels on both sides of the width direction. This makes it possible to generate adjustment coefficients with ease, compared to when finding adjustment coefficients by calculating the ratio between the brightness of a bird's-eye-view image and the brightness of an accumulated image for every pixel, so that the burden of calculation on the coefficient calculation part 114 can be reduced.

For ease of explanation, assume, for example, that 10 pixels are aligned in the direction in which the moving body 200 moves, and 5 pixels are aligned in the direction (that is, in the width direction) that is orthogonal to the direction in which the moving body moves, in the area UA underneath the vehicle. For example, if the adjustment coefficients a0 and b0 are 0.5, the adjustment coefficients for 10 pixels aligned from the back to the front of the moving body 200 in the area UA underneath the vehicle increase by approximately 0.0556 per pixel, from the back to the front, which gives 0.5, 0.556, 0.611, . . . , 0.889, 0.944, and 1.0.

If the adjustment coefficient b0 is 0.4, the adjustment coefficients for the 10 pixels aligned between sampling point Pb0 and sampling point Pb2 of the moving body 200 in the area UA underneath the vehicle increase by approximately 0.0667 per pixel, from the back to the front, which gives 0.4, 0.467, 0.533, . . . , 0.867, 0.933, and 1.0.

If the adjustment coefficient a0 is 0.5 and the adjustment coefficient b0 is 0.4, for example, the coefficient calculation part 114 sets the adjustment coefficients for the 3 pixels that are aligned, in the area UA underneath the vehicle, between the pixel corresponding to the adjustment coefficient 0.611 and located on the left side relative to the direction in which the moving body 200 moves, and the pixel corresponding to the adjustment coefficient 0.533 and located on the right side relative to the direction in which the moving body 200 moves, to 0.553, 0.572, and 0.592, respectively.

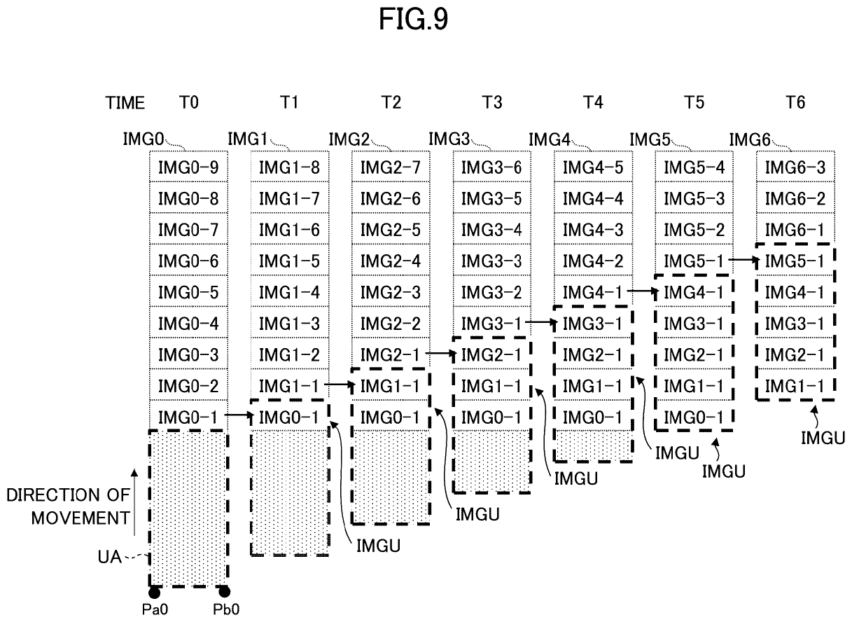

FIG. 9 is an explanatory view that illustrates an example method that the image processing device 110 of FIG. 1 uses to generate images IMGU of the underneath of the vehicle. For example, the image data obtaining part 111 of FIG. 2 stores image data IMG0, IMG1, IMG2, IMG3, IMG4, IMG5, and IMG6 in the image accumulating part 119 in order. The image data is obtained at predetermined time intervals, by the image capturing device 210A installed in the front of the moving body 200 in the direction in which the moving body 200 moves. Below, image data IMG0 to IMG6 stocked in the image accumulating part 119 will be also referred to as “accumulated images IMG0 to IMG6.”

The actual accumulated images IMG0 to IMG6 contain a photographing object's images that spread out like a fan, as illustrated in FIG. 4. However, for ease of explanation, FIG. 9 only shows images that can overlap the area UA underneath the vehicle, which moves following the movement of the moving body 200. Also, image data IMG0 to IMG6 each include a number of sub-image data IMG, indicated by branch numbers “−1,” “−2,” and so on. Furthermore, the image IMGU of the underneath of the vehicle displayed in the area UA underneath the vehicle is generated by merging up to five sub-image data IMG together. Note that the number of sub-image data IMG for use in generating the image IMGU of the underneath of the vehicle varies depending on the frame rate of the image capturing devices 210 and the speed at which the moving body 200 moves.

At time T0, the moving body 200 starts moving. When the moving body 200 starts moving, the image accumulating part 119 holds no accumulated image corresponding to the area UA underneath the vehicle. Therefore, the image-under-the-vehicle generating part 113 generates no image IMGU of the underneath of the vehicle.

Next, at time T1, the image-under-the-vehicle generating part 113 determines that sub-image IMG0-1 of accumulated image IMG0 at time T0 is currently included in the area UA underneath the vehicle due to the movement of the moving body 200. So, the image-under-the-vehicle generating part 113 cuts out sub-image IMG0-1 from sub-image IMG0.

The image-under-the-vehicle generating part 113 outputs the two-dimensional coordinates of each pixel of sub-image IMG0 to the projection part 112. The projection part 112 generates the three-dimensional coordinates of sub-image IMG0-1 on the projection surface 230, per pixel, based on projection information held in the projection information storage part 118. The projection part 112 outputs the three-dimensional coordinates generated, to the image-under-the-vehicle generating part 113. The image-under-the-vehicle generating part 113 outputs three-dimensional sub-image data IMG0-1, including the three-dimensional coordinates that have arrived from the projection part 112, to the merging part 116. Note that the projection part 112 converts two-dimensional image data IMGa to IMGd, generated on a real-time basis by the image capturing devices 210A to 210D, into three-dimensional image data IMGa to IMGd, and outputs these to the merging part 116.

The merging part 116 merges three-dimensional sub-image IMG0-1 having arrived from the image-under-the-vehicle generating part 113 and three-dimensional image data IMGa to IMGd of time T1 having arrived from the projection part 112 together, thereby generating a bird's-eye-view image incorporating an image IMGU of the underneath of the vehicle. The merging part 116 outputs the generated bird's-eye-view image to the display device 130 via the output part 117. By this means, a bird's-eye-view image incorporating an image IMGU of the underneath of the vehicle can be displayed on the display device 130.

Next, at time T2, the image-under-the-vehicle generating part 113 determines that, now that the moving body 200 has moved, sub-image IMG0-1 at time T0 and sub-image IMG1-1 at time T1 are currently included in the area UA underneath the vehicle. Therefore, the image-under-the-vehicle generating part 113 outputs the two-dimensional coordinates of each pixel of sub-images IMG0-1 and IMG1-1 to the projection part 112.

Subsequently, as at time T1, the merging part 116 receives three-dimensional sub-image data IMG0-1 and IMG1-1 from the image-under-the-vehicle generating part 113, and receives three-dimensional image data IMGa to IMGd from the projection part 112. Then, the merging part 116 merges three-dimensional sub-images IMG0-1 and IMG1-1 and three-dimensional image data IMGa to IMGd at time T2 together, thereby generating a bird's-eye image incorporating an image IMGU of the underneath of the vehicle and displaying it on the display device 130.

At times T3 and T4, the image-under-the-vehicle generating part 113, projection part 112, and merging part 116 operate the same or substantially the same as at times T1 and T2. At time T3, three-dimensional sub-images IMG0-1, IMG1-1 and IMG2-1 and three-dimensional image data IMGa to IMGd at time T3 are merged together, and a bird's-eye-view image incorporating an image IMGU of the underneath of the vehicle is displayed on display device 130.

At time T4, three-dimensional sub-images IMG0-1, IMG1-1, IMG2-1, and IMG3-1 and three-dimensional image data IMGa to IMGd at time T4 are merged together, and a bird's-eye-view image incorporating an image IMGU of the underneath of the vehicle is generated and displayed on the display device 130.

Note that, up until time T4, there are no images of sampling points Pa0 and Pb0 in the accumulated images, and so the coefficient calculation part 114 calculates no adjustment coefficients. It then follows that the adjustment part 115 does not adjust the brightness of the image IMGU of the underneath of the vehicle incorporated in the bird's-eye-view image either. During the period in which the accumulated images show no images of sampling points Pa0 and Pb0, calculation of adjustment coefficients by the coefficient calculation part 114 and adjustment of brightness by the adjustment part 115 are prevented or substantially prevented, so that the processing load on the image processing device 110 can be reduced. By this means, for example, the power consumption of the image processing device 110 can be reduced.

At time T5, the accumulated images include images of sampling points Pa0 and Pb0. So, the coefficient calculation part 114 calculates adjustment coefficient in the same way as has been described earlier with reference to FIG. 8. After the adjustment coefficients are calculated, the image-under-the-vehicle generating part 113 outputs the three-dimensional image IMGU of the underneath of the vehicle, including the three-dimensional coordinates that have arrived from the projection part 112, to the adjustment part 115. Note that the image IMGU of the underneath of the vehicle includes sub-image data IMG0-1, IMG1-1, IMG2-1, IMG3-1, and IMG4-1.

The adjustment part 115 adjusts the brightness of the three-dimensional image IMGU of the underneath of the vehicle having arrived from the image-under-the-vehicle generating part 113, based on the adjustment coefficients. The image IMGU of the underneath of the vehicle, having undergone adjustment of brightness, is output to the merging part 116. Subsequently, as at time T1 to time T4, the three-dimensional image IMGU of the underneath of the vehicle, having arrived from part 115 after its brightness is adjusted, and three-dimensional image data IMGa to IMGd at time T5, having arrived from the projection part 112, are merged together in the merging part 116.

Then, the merging part 116 generates a bird's-eye-view image incorporating the image IMGU of the underneath of the vehicle, and outputs the generated bird's-eye-view image to the display device 130 via the output part 117. By this means, it is possible to display a bird's-eye-view image that incorporates an image IMGU of the underneath of the vehicle having undergone adjustment of brightness in accordance with image data IMGa to IMGd generated on a real-time basis, and that therefore looks less awkward, on the display device 130. In other words, even if a bird's-eye-view image and an image IMGU of the underneath of the vehicle are generated at different times and therefore vary in brightness, it is still possible to display a bird's-eye-view image, in which the awkwardness due to difference in brightness between images is reduced, on the display device 130. Note that, at time T5 and later, as long as the moving body 200 continues moving in the same direction, the image IMGU of the underneath of the vehicle is displayed over the entire area UA underneath the vehicle.

Next, at time T6, the image-under-the-vehicle generating part 113 determines that sub-image IMG0-1 has gone out of the area UA underneath the vehicle, and that sub-images IMG1-1, IMG2-1, IMG3-1, IMG4-1, and IMG5-1 are presently included in the area UA underneath the vehicle. Subsequently, the image-under-the-vehicle generating part 113, projection part 112, and merging part 116 operate the same or substantially the same as at time T5, and a bird's-eye-view image that incorporates an image IMGU of the underneath of the vehicle having undergone adjustment of brightness and that therefore looks less awkward, is displayed on the display device 130.

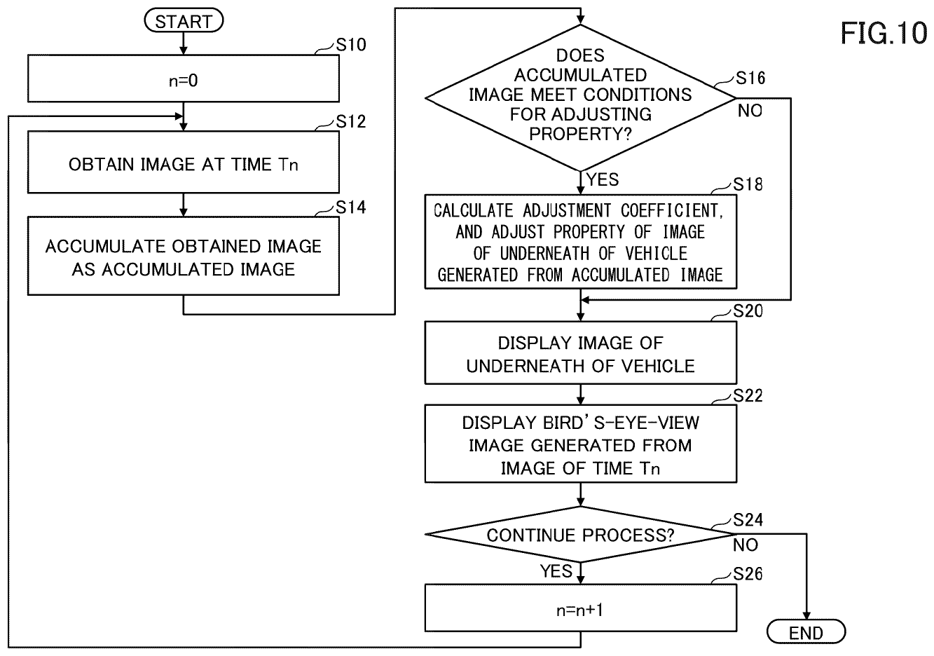

FIG. 10 is a flowchart that illustrates an example operation of the image processing device 110 of FIG. 2. That is, FIG. 10 shows an example of an image processing method by the image processing device 110, and also shows an example of an image processing program that the image processing device 110 runs.

First, in step S10, the image processing device 110 initializes a counter's value n to “0.” Next, in step S12, the image data obtaining part 111 of the image processing device 110 obtains images at time Tn, from the image capturing devices 210A to 210D. In step S14, the image data obtaining part 111 accumulates the image obtained from an image capturing device 210 (for example, 210A) installed in the direction in which the moving body 200 moves, in the image accumulating part 119, as an accumulated image.

Next, in step S16, the image processing device 110 determines whether any of the accumulated images stocked in the image accumulating part 119 meets the conditions for property adjustment. For example, in FIG. 9, the conditions for property adjustment are not met at times T0 to T4; at times T5 and T6, the conditions for property adjustment are met. When the conditions for property adjustment are met, the process moves on to step S20. When the conditions for property adjustment are not met, the process moves on to step S18. For example, the process of step S16 is executed by the image-under-the-vehicle generating part 113.

In step S18, the coefficient calculation part 114 of the image processing device 110 calculates adjustment coefficients by using the method illustrated in FIG. 8. Using the adjustment coefficients calculated, the adjustment part 115 of the image processing device 110 adjusts the property of a three-dimensional image IMGU of the underneath of the vehicle, generated from the accumulated images so as to be suitable to the projection surface 230. For example, the image processing device 110 adjusts the brightness of the three-dimensional image IMGU of the underneath of the vehicle based on the adjustment coefficients calculated. After step S18, the image processing device 110 moves on to step S20.

In step S20, the image processing device 110 displays the three-dimensional image IMGU of the underneath of the vehicle, cut out from the accumulated images, on the display device 130, and thereupon the process moves on to step S22. If it is determined in step S16 that the conditions for property adjustment are met, the image processing device 110 displays the image IMGU of the underneath of the vehicle having undergone property adjustment, on the display device 130. If it is determined in step S16 that the conditions for property adjustment are not met, the image processing device 110 displays the image IMGU of the underneath of the vehicle, the property of which has not been adjusted, on the display device 130. Note that if there is no image IMGU of the underneath of the vehicle as at time T0 illustrated in FIG. 9, the image processing device 110 may skip the process of step S20.

Next, in step S22, the image processing device 110 displays, on the display device 130, a bird's-eye-view image generated from the images obtained from the image capturing devices 210A to 210D at time Tn. For example, the processes of steps S20 and S22 are executed by the output part 117.

Next, in step S24, when the image processing device 110 continues the process of displaying the bird's-eye-view image, the process moves on to step S26. If the image processing device 110 stops the process of displaying the bird's-eye-view image, the process illustrated in FIG. 10 ends. In step S26, the image processing device 110 updates the counter's value n to “1,” and thereupon the process returns to step S12.

Note that the image processing device 110 may execute the processes of steps S20 and S22 in one process. In this case, if the conditions for adjusting property are met, the image processing device 110 generates a bird's-eye-view image by merging an image IMGU of the underneath of the vehicle having undergone property adjustment and image data IMG obtained on a real-time basis together. On the other hand, if the conditions for adjusting property are not met, the image processing device 110 generates a bird's-eye-view image by merging an image IMGU of the underneath of the vehicle not having undergone property adjustment and image data IMG obtained on a real-time basis together. Note that, if there is no image IMGU of the underneath of the vehicle, the image processing device 110 generates a bird's-eye-view image from the image data IMG obtained on a real-time basis alone.

As described above, according to this embodiment, the adjustment part 115 adjusts the brightness of images of the underneath of the vehicle based on adjustment coefficients calculated in the coefficient calculation part 114. This allows the image processing device 110 to generate an image IMGU of the underneath of the vehicle that looks less awkward compared to a bird's-eye-view image that is generated on a real-time basis. That is, according to this embodiment, it is possible to prevent or substantially prevent, when a bird's-eye-view image and an image IMGU of the underneath of the vehicle are merged together, the resulting image from looking unnatural. In other words, according to this embodiment, even if a bird's-eye-view image and an image IMGU of the underneath of the vehicle are generated at different times and vary in brightness, it is still possible to display a bird's-eye-view image, the awkward look of which due to the difference in brightness is reduced, on the display device 130.

The coefficient calculation part 114 first calculates reference adjustment coefficients at the positions of the vertices of a rectangular boundary portion formed between a bird's-eye-view image and an image of the underneath of the vehicle before they are merged in the merging part 116. Using these reference adjustment coefficients, the coefficient calculation part 114 calculates the adjustment coefficient for every pixel in the image IMGU of the underneath of the vehicle. In this way, calculation of a minimal number of reference adjustment coefficients allows the coefficient calculation part 114 to calculate the adjustment coefficient for every pixel in the image IMGU of the underneath of the vehicle, so that the amount of calculation can be reduced.

The coefficient calculation part 114 calculates the adjustment coefficient for each pixel positioned between sampling points Pa0 and Pa2 in the area UA underneath the vehicle, and the adjustment coefficient for each pixel positioned between sampling points Pb0 and Pb2 in the area UA underneath the vehicle, by linear interpolation. When this takes place, at the front end of the image IMGU of the underneath of the vehicle in the direction in which the moving body 200 moves, the pixels of the bird's-eye-view image and the image IMGU of the underneath of the vehicle show pixel values (for example, brightness values) that vary only slightly, so that the adjustment coefficients for sampling points Pa2 and Pb2 can be set to “1.0,” regardless of the image.

Also, the coefficient calculation part 114 calculates the adjustment coefficients for pixels aligned in the width direction of the image IMGU of the underneath of the vehicle by linearly interpolating the adjustment coefficients calculated for pixels on both sides of the width direction. In this way, adjustment coefficients can be generated with ease, compared to the case in which adjustment coefficients are found by calculating the ratio between the brightness of a bird's-eye-view image and the brightness of an accumulated image on a per pixel basis, so that the burden of calculation on the coefficient calculation part 114 can be reduced.

By stopping or substantially stopping the calculation of adjustment coefficients by the coefficient calculation part 114 and the adjustment of brightness by the adjustment part 115 during the period in which there are no images of sampling points Pa0 and Pb0 in accumulated images, the processing load on the image processing device 110 can be reduced. By this means, for example, the power consumption of the image processing device 110 can be reduced.

The coefficient calculation part 114 uses multiple pixels including the pixels of sampling points Pa0 and Pb0 in calculating the average brightness, so that, for example, even when the brightness of the pixels of sampling point Pa0 or Pb0 shows an irregular value due to noise or the like, it is still possible to calculate an average brightness within a normal range.

### Second Embodiment

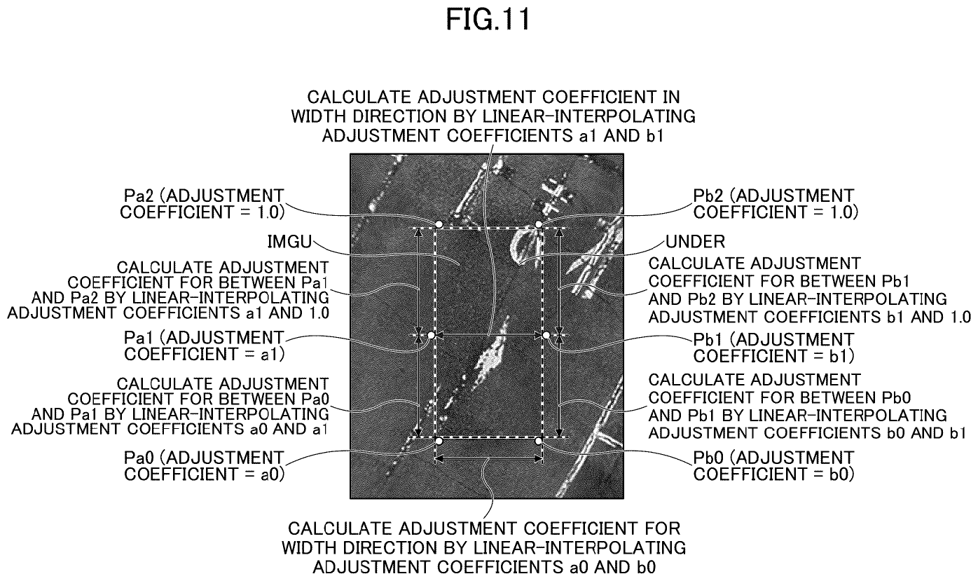

FIG. 11 is an explanatory view that illustrates an example method of calculating adjustment coefficients that an image processing device according to a second embodiment uses to adjust the brightness of images of the underneath of a vehicle. Components that are the same or substantially the same as in the embodiment described above will be described using the same reference codes. The image processing device 110 of this embodiment and the image processing system 100 including the image processing device 110 are structured the same or substantially the same as illustrated in FIG. 1 to FIG. 3, and are mounted in the moving body 200, for example. Processes that are the same or substantially the same as in the adjustment coefficient calculation method described above with reference to FIG. 7 and FIG. 8 will not be described in detail below.

As in FIG. 9, the method of calculating adjustment coefficients illustrated in FIG. 11 is started when any one of the accumulated images stocked in the image accumulating part 119 includes a predetermined number of pixels (for example, 9 pixels), including sampling points Pa0 and Pb0 of the area UA underneath the vehicle at the current position of the moving body 200.

According to this embodiment, a sampling point Pa1 is set between sampling points Pa0 and Pa2, and a sampling point Pb1 is set between sampling points Pb0 and Pb2. The method of calculating an adjustment coefficient a1 at sampling point Pa1 and the method of calculating an adjustment coefficient b1 at sampling point Pb1 are the same or substantially the same as the method of calculating adjustment coefficients a0 and b0 at sampling points Pa0 and Pb0, which has been described above with reference to FIG. 8. Also, the adjustment coefficients for sampling points Pa2 and Pb2 are set to “1.0,” as in FIG. 8.

The coefficient calculation part 114 makes Ar1/Au1, which is the ratio between the average brightness Ar1 of the bird's-eye-view image and the average brightness Au1 of the accumulated image at sampling point Pa1, an adjustment coefficient a1. Also, the coefficient calculation part 114 makes Br1/Bu1, which is the ratio between the average brightness Br1 of the bird's-eye-view image and the average brightness Bu1 of the accumulated image at sampling point Pa1, an adjustment coefficient b1.

Then, the coefficient calculation part 114 calculates the adjustment coefficient for every pixel in the area UA underneath the vehicle, between sampling points Pa0 and Pa1, by linear interpolation using the adjustment coefficient a0 for sampling point Pa0 and the adjustment coefficient a1 for sampling point Pa1. Also, the coefficient calculation part 114 calculates the adjustment coefficient for each pixel in the area UA underneath the vehicle, between sampling points Pa1 and Pa2, by linear interpolation using the adjustment coefficient a1 for sampling point Pa1 and the adjustment coefficient a2 for sampling point Pa2.

Likewise, the coefficient calculation part 114 calculates the adjustment coefficient for every pixel in the area UA underneath the vehicle, between sampling points Pb0 and Pb1, by linear interpolation using the adjustment coefficient b0 for sampling point Pb0 and the adjustment coefficient b1 for sampling point Pb1. Also, the coefficient calculation part 114 calculates the adjustment coefficient for each pixel in the area UA underneath the vehicle, between sampling points Pb1 and Pb2, by linear interpolation using the adjustment coefficient b1 for sampling point Pb1 and the adjustment coefficient b2 for sampling point Pb2.

That is, using the adjustment coefficients a0 and a1 calculated at two sampling points (for example, Pa0 and Pa1) that neighbor each other in the direction in which the moving body 200 moves, the coefficient calculation part 114 calculates the adjustment coefficients for the pixels positioned between the two neighboring sampling points.

Furthermore, as in FIG. 8, the coefficient calculation part 114 calculates the adjustment coefficient for each pixel arranged in the width direction of the moving body 200 in the area UA underneath the vehicle, by linear interpolation using, among the adjustment coefficients calculated above by linear interpolation, adjustment coefficients a and b pertaining to the same positions in the direction in which the moving body 200 moves in the area UA underneath the vehicle. Note that the coefficient calculation part 114 need not calculate adjustment coefficients by linear interpolation for every single pixel; instead, the coefficient calculation part 114 may calculate adjustment coefficients for every desired number of pixels.

Also, the coefficient calculation part 114 can calculate adjustment coefficients for adjusting the brightness of all pixels in the area UA underneath the vehicle. The adjustment part 115 adjusts the brightness of a three-dimensional image IMGU of the underneath of the vehicle, having arrived from the image-under-the-vehicle generating part 113, based on the adjustment coefficients, and outputs the image IMGU of the underneath of the vehicle, having undergone adjustment of brightness, to the merging part 116. The merging part 116 generates a bird's-eye-view image incorporating an image IMGU of the underneath of the vehicle by merging the image IMGU of the underneath of the vehicle having undergone adjustment of brightness and the bird's-eye-view image that have arrived from the adjustment part 115 together. The display device 130 displays the bird's-eye-view image incorporating the image IMGU of the underneath of the vehicle having arrived from the adjustment part 115, via the output part 117.

Note that FIGS. 4, 6, and 9 also apply to this embodiment. Also, two or more sampling points may be set between sampling points Pa0 and Pa2, or two or more sampling points may be set between sampling points Pb0 and Pb2.

As described above, this embodiment can bring about the same advantages as those of the embodiment described earlier. Furthermore, according to this embodiment, the coefficient calculation part 114 calculates adjustment coefficients for between sampling points by using four pairs of sampling points as reference points, including the pairs of sampling points Pa0 and Pa1, sampling points Pa1 and Pa2, sampling points Pb0 and Pb1, and sampling points Pb1 and Pb2. By this means, the accuracy of the calculation of adjustment coefficients can be improved compared to the case in which adjustment coefficients are calculated based on two pairs of sampling points. As a result of this, the image processing device 110 can generate under-the-vehicle images IMGU that look even less awkward compared to bird's-eye view images that are generated on a real-time basis. That is, according to this embodiment, it is possible to prevent or substantially prevent, when a bird's-eye-view image and an image IMGU of the underneath of the vehicle are merged together, the resulting image from looking unnatural.

Although the present invention has been described above based on embodiments, the present invention is by no means limited to the details described in the above embodiments, and they can be changed in a variety of ways without departing from the scope of the present invention and can be determined as appropriate depending on the mode of implementation.

1. An image processing device comprising:
an image accumulating part configured to accumulate images obtained from a plurality of image capturing devices as accumulated images, the plurality of image capturing devices being provided in a moving body;
an overlapping image generating part configured to generate an overlapping image from accumulated images in the image accumulating part, the overlapping image showing an area that overlaps the moving body and is not included in a field of view of the plurality of image capturing devices;
a merging part configured to generate a first bird's-eye-view image that shows surroundings of the moving body by merging the images obtained from the plurality of image capturing devices together, and generate a second bird's-eye-view image by merging the first bird's-eye-view image and the overlapping image together;
a coefficient calculation part configured to calculate adjustment coefficients in a boundary portion formed between the first bird's-eye-view image and the overlapping image, based on property information of the first bird's-eye-view image and property information of the accumulated images used to generate the overlapping image; and
an adjustment part configured to adjust the property of the overlapping image to be merged with the first bird's-eye-view image by the merging part, based on the adjustment coefficients calculated by the coefficient calculation part.

2. The image processing device according to claim 1, wherein the coefficient calculation part is further configured to calculate reference adjustment coefficients at positions of vertices of the boundary portion, which is rectangular in shape, and calculate an adjustment coefficient for every pixel in the overlapping image by using the reference adjustment coefficients calculated.

3. The image processing device according to claim 1, wherein the coefficient calculation part is further configured to:
calculate reference adjustment coefficients at positions of vertices in a direction in which the moving body moves and at least one position between the vertices in the direction in which the moving body moves; and
calculate adjustment coefficients for pixels between two positions that neighbor each other in the direction in which the moving body moves, by using the reference adjustment coefficients calculated at the two positions that neighbor each other.

4. The image processing device according to claim 2, wherein the coefficient calculation part is further configured to calculate, by linear interpolation using two reference adjustment coefficients calculated at two positions in the direction in which the moving body moves, adjustment coefficients for pixels between the two positions in the overlapping image.

5. The image processing device according to claim 4, wherein the coefficient calculation part is further configured to calculate, in the overlapping image, adjustment coefficients for pixels in a direction that is orthogonal to the direction in which the moving body moves, by linear interpolation using the adjustment coefficients calculated at positions in the orthogonal direction.

6. The image processing device according to claim 2, wherein the coefficient calculation part is further configured to set a reference adjustment coefficient at a vertex to 1.0, the vertex being located forward in the direction in which the moving body moves.

7. The image processing device according to claim 2,
wherein the coefficient calculation part is further configured not to calculate the adjustment coefficients unless an image corresponding to one of the vertices of the rectangular boundary portion is included in the overlapping image generated by the overlapping image generating part, and
wherein the adjustment part is further configured not to adjust the property of the overlapping image to be merged with the first bird's-eye-view image by the merging part unless the coefficient calculation part calculates the adjustment coefficients.

8. The image processing device according to claim 1, wherein the coefficient calculation part is further configured to calculate an average value of property information of a plurality of pixels in the boundary portion, and calculate adjustment coefficients based on the average value calculated.

9. The image processing device according to claim 1,
wherein the first bird's-eye-view image is generated by merging together, on a real-time basis, the images obtained from the plurality of image capturing devices,
wherein the overlapping image is generated from past accumulated images stocked in the image accumulating part, and
wherein the second bird's-eye-view image is generated by merging the first bird's-eye-view image and the overlapping image together.

10. An image processing method comprising:
accumulating images obtained from a plurality of image capturing devices as accumulated images, the plurality of image capturing devices being provided in a moving body;
generating an overlapping image from accumulated images, the overlapping image showing an area that overlaps the moving body and is not included in a field of view of the plurality of image capturing devices;
generating a first bird's-eye-view image that shows surroundings of the moving body by merging the images obtained from the plurality of image capturing devices together, and generating a second bird's-eye-view image by merging the first bird's-eye-view image and the overlapping image together;
calculating adjustment coefficients in a boundary portion formed between the first bird's-eye-view image and the overlapping image, based on property information of the first bird's-eye-view image and property information of the accumulated images used to generate the overlapping image; and
adjusting a property of the overlapping image to be merged with the first bird's-eye-view image, based on the adjustment coefficients calculated.

11. A computer-readable non-transitory recording medium storing a program that, when executed on a computer, causes the computer to perform the image processing method of claim 10.
